(19) United States
(12) Patent Application Publication
(10) Pub. No.: US 2013/0299807 A1
(43) Pub. Date: Nov. 14, 2013

(54) ELECTROACTIVE COMPOSITION

(71) Applicants: Vsevolod Rostovtsev, Swarthmore, PA (US); Weiying Gao, Landenberg, PA (US)

(72) Inventors: Vsevolod Rostovtsev, Swarthmore, PA (US); Weiying Gao, Landenberg, PA (US)

(73) Assignee: E I DU PONT DE NEMOURS AND COMPANY, Wilmington, DE (US)

(21) Appl. No.: 13/979,739

(22) PCT Filed: Feb. 14, 2012
(86) PCT No.: PCT/US12/25025

§ 371 Date: Jul. 15, 2013

Related U.S. Application Data
(60) Provisional application No. 61/442,398, filed on Feb. 14, 2011.

(51) Int. Cl. C09K 11/06

(52) U.S. Cl. CPC C09K 11/06
USPC 257/40; 252/301.16

(57) ABSTRACT

There is provided an electroactive composition including (a) a host, (b) a dopant, and (c) an additive having Formula I

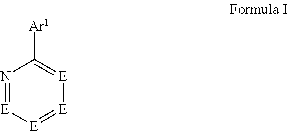

In Formula I, E is the same or different at each occurrence and is N or C—Ar¹ and Ar¹ is the same or different at each occurrence and is H, D, or aryl. At least one E=N, and at least one Ar¹ is aryl.

### RELATED APPLICATION DATA

This application claims priority under 35 U.S.C. §119(e) from U.S. Provisional Application No. 61/442,398 filed on Feb. 14, 2011, and Provisional Application No. 61/466,195 filed on Mar. 22, 2011, both of which are incorporated by reference herein in their entirety.

### BACKGROUND INFORMATION

1. Field of the Disclosure

This disclosure relates in general to electroactive materials and their synthesis.

2. Description of the Related Art

Organic electronic devices that emit light, such as light-emitting diodes that make up displays, are present in many different kinds of electronic equipment. In all such devices, an organic active layer is sandwiched between two electrical contact layers. At least one of the electrical contact layers is light-transmitting so that light can pass through the electrical contact layer. The organic active layer emits light through the light-transmitting electrical contact layer upon application of electricity across the electrical contact layers.

It is well known to use organic electroluminescent compounds as the active component in light-emitting diodes. Simple organic molecules, such as anthracene, thiadiazole derivatives, and coumarin derivatives are known to show electroluminescence. In some cases these small molecule materials are present as a dopant in a host material to improve processing and/or electronic properties.

There is a continuing need for new electroactive materials, especially for luminescent compounds that are blue-emitting.

### SUMMARY

There is provided an electroactive composition comprising (a) a host, (b) a dopant, and (c) an additive having Formula I

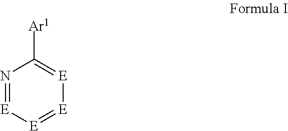

wherein:
E is the same or different at each occurrence and is N or C—Ar¹, with the proviso that at least one E=N; and
Ar¹ is the same or different at each occurrence and is H, D, or aryl; with the proviso that at least one Ar¹ is aryl.

There is also provided an organic electronic device comprising a first electrical contact, a second electrical contact and a photoactive layer therebetween, the photoactive layer comprising the above electroactive composition.

The foregoing general description and the following detailed description are exemplary and explanatory only and are not restrictive of the invention, as defined in the appended claims.

### BRIEF DESCRIPTION OF THE DRAWINGS

Embodiments are illustrated in the accompanying figures to improve understanding of concepts as presented herein.

FIG. 1A includes a diagram illustrating HOMO and LUMO levels.

FIG. 1B includes a diagram illustrating HOMO and LUMO levels for two different materials.

FIG. 1C includes a diagram illustrating band gap.

FIG. 2 includes an illustration of an organic light-emitting device.

FIG. 3 includes another illustration of an organic light-emitting device.

Skilled artisans appreciate that objects in the figures are illustrated for simplicity and clarity and have not necessarily been drawn to scale. For example, the dimensions of some of the objects in the figures may be exaggerated relative to other objects to help to improve understanding of embodiments.

### DETAILED DESCRIPTION

Many aspects and embodiments have been described above and are merely exemplary and not limiting. After reading this specification, skilled artisans appreciate that other aspects and embodiments are possible without departing from the scope of the invention.

Other features and benefits of any one or more of the embodiments will be apparent from the following detailed description, and from the claims. The detailed description first addresses Definitions and Clarification of Terms followed by the Additive, the Electroactive Composition, Devices, and finally Examples.

### 1. DEFINITIONS AND CLARIFICATION OF TERMS

Before addressing details of embodiments described below, some terms are defined or clarified.

The term “alkoxy” is intended to mean a group having the formula —OR, which is attached via the oxygen, where R is an alkyl.

The term “alkyl” is intended to mean a group derived from an aliphatic hydrocarbon and includes a linear, a branched, or a cyclic group. In some embodiments, an alkyl has from 1-20 carbon atoms.

The term “aromatic compound” is intended to mean an organic compound comprising at least one unsaturated cyclic group having delocalized pi electrons.

The term “aryl” is intended to mean a group derived from an aromatic compound. The term includes groups which have a single ring and those which have multiple rings which can be joined by a single bond or fused together. The term is intended to include heteroaryls. The term “hydrocarbon aryl” is intended to mean an aryl having no heteroatoms in the ring. In some embodiments, an aryl group has from 3-60 carbon atoms.

The term “aryloxy” is intended to mean a group having the formula —OAr, which is attached via the oxygen, where Ar is an aryl.

The term “binaphthyl” is intended to mean a group having two naphthalene units joined by a single bond. In some embodiments, the binaphthyl group is 1,1-binaphthyl, which is attached at the 3-, 4-, or 5-position; in some embodiments, 1,2-binaphthyl, which is attached at the 3-, 4-, or 5-position on the 1-naphthyl moiety, or the 4- or 5-position on the 2-naphthyl moiety; and in some embodiments, 2,2-binaphthyl, which is attached at the 4- or 5-position.

The term “biphenyl” is intended to mean a group having two phenyl units joined by a single bond. The group can be attached at the 2-, 3-, or 4-position.

The term “carbazolyl” refers to the substituent group

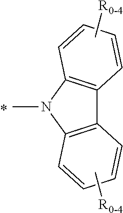

where R is D, alkyl, or aryl, and the asterisk represents the point of attachment.

The term “charge transport,” when referring to a layer, material, member, or structure is intended to mean such layer, material, member, or structure facilitates migration of such charge through the thickness of such layer, material, member, or structure with relative efficiency and small loss of charge. Hole transport materials facilitate migration of the positive charge; electron transport materials facilitate migration of the negative charge. Although light-emitting materials may also have some charge transport properties, the term “charge transport layer, material, member, or structure” is not intended to include a layer, material, member, or structure whose primary function is light emission.

The term “deuterated” is intended to mean that at least one H has been replaced by D. The term “deuterated analog” refers to a structural analog of a compound or group in which one or more available hydrogens have been replaced with deuterium. In a deuterated compound or deuterated analog, the deuterium is present in at least 100 times the natural abundance level. The “% deuterated” or “% deuteration” is intended to mean the ratio of deuterons to the total of hydrogens plus deuterons, expressed as a percentage.

The term “dopant” is intended to mean a material, within a layer including a host material or materials, that changes the electronic characteristic(s) or the targeted wavelength(s) of radiation emission, reception, or filtering of the layer compared to the electronic characteristic(s) or the wavelength(s) of radiation emission, reception, or filtering of the layer in the absence of such material.

The term “electroactive” as it refers to a layer or a material, is intended to indicate a layer or material which electronically facilitates the operation of the device. Examples of active materials include, but are not limited to, materials which conduct, inject, transport, or block a charge, where the charge can be either an electron or a hole, or materials which emit radiation or exhibit a change in concentration of electron-hole pairs when receiving radiation. Examples of inactive materials include, but are not limited to, insulating materials and environmental barrier materials.

The term “electron-donating” as it refers to a substituent group is intended to mean a group which, when present on an aromatic ring, adds to the electron density of the aromatic ring.

The term “electron-withdrawing” as it refers to a substituent group is intended to mean a group which, when present on an aromatic ring, decreases the electron density of the aromatic ring.

The prefix “hetero” indicates that one or more carbon atoms have been replaced with a different atom. In some embodiments, the different atom is N, O, or S.

The term “host material” is intended to mean a material, usually in the form of a layer, in which a dopant may be present. The host material may or may not have electronic characteristic(s) or the ability to emit, receive, or filter radiation.

The terms “luminescent material” and “emitter” are intended to mean a material that emits light when activated by an applied voltage (such as in a light-emitting diode or light-emitting electrochemical cell).

The term “layer” is used interchangeably with the term “film” and refers to a coating covering a desired area. The term is not limited by size. The area can be as large as an entire device or as small as a specific functional area such as the actual visual display, or as small as a single sub-pixel. Layers and films can be formed by any conventional deposition technique, including vapor deposition, liquid deposition (continuous and discontinuous techniques), and thermal transfer. Continuous deposition techniques, include but are not limited to, spin coating, gravure coating, curtain coating, dip coating, slot-die coating, spray coating, and continuous nozzle coating or printing. Discontinuous deposition techniques include, but are not limited to, ink jet printing, gravure printing, and screen printing.

The term “organic electronic device” or sometimes just “electronic device” is intended to mean a device including one or more organic semiconductor layers or materials.

The term “photoactive” refers to a material or layer that emits light when activated by an applied voltage (such as in a light emitting diode or chemical cell) or responds to radiant energy and generates a signal with or without an applied bias voltage (such as in a photodetector or a photovoltaic cell).

The term “siloxane” refers to the group R₃SiO—, where R is H, D, C1-20 alkyl, fluoroalkyl, or aryl. In some embodiments, one or more carbons in an R alkyl group are replaced with Si.

The term “silyl” refers to the group R₃Si—, where R is H, D, C1-20 alkyl, fluoroalkyl, or aryl. In some embodiments, one or more carbons in an R alkyl group are replaced with Si.

All groups may be unsubstituted or substituted. In some embodiments, the substituents are selected from the group consisting of D, halide, alkyl, alkoxy, aryl, aryloxy, silyl, siloxane, and cyano.

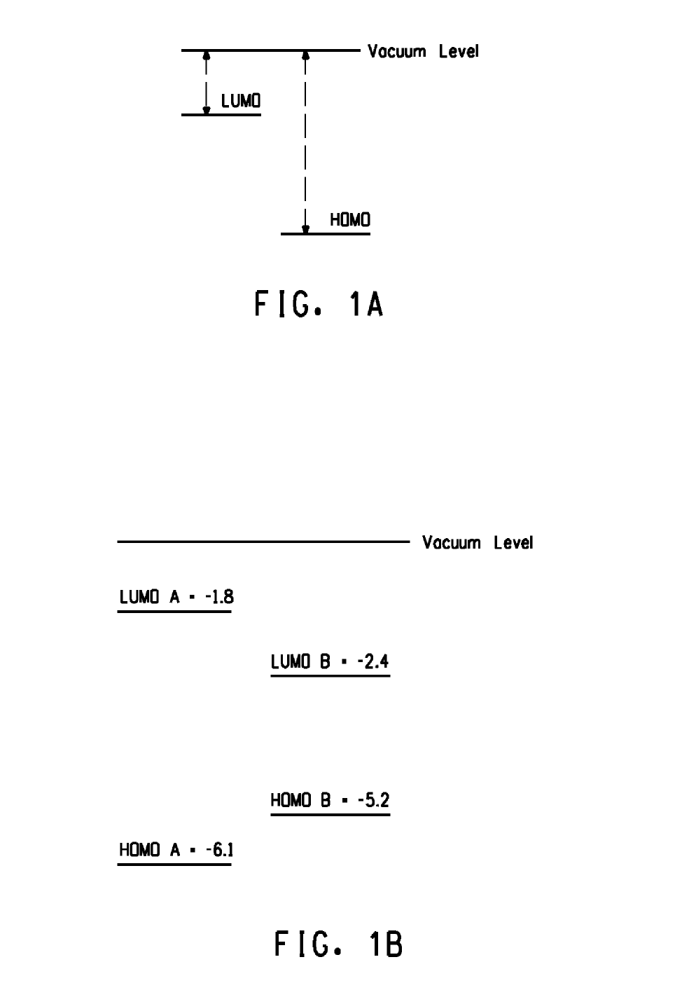

The energy levels are illustrated in FIGS. 1A-1C. The term “HOMO” refers to the highest occupied molecular orbital. The HOMO energy level is measured relative to vacuum level, as illustrated in FIG. 1A. By convention, the HOMO is given as a negative value, i.e. the vacuum level is set as zero and the bound electron energy levels are deeper than this. The term “LUMO” refers to the lowest unoccupied molecular orbital. The LUMO energy level is measured relative to vacuum level in eV, as illustrated in FIG. 1A. By convention, the LUMO is a negative value, i.e. the vacuum level is set as zero and the bound electron energy levels are deeper than this. By “shallower” it is meant that an energy level is closer to the vacuum level. This is illustrated in FIG. 1B, where HOMO B is shallower than HOMO A. By “deeper” it is meant than an energy level is farther removed from vacuum level. This is illustrated in FIG. 1B, where LUMO B is deeper than LUMO A. The term “band gap” refers to the difference in energy between the HOMO and LUMO levels of a material, as shown in FIG. 1C. The band gap is reported as a positive number in eV.

As used herein, the terms “comprises,” “comprising,” “includes,” “including,” “has,” “having” or any other variation thereof, are intended to cover a non-exclusive inclusion. Unless explicitly stated otherwise or indicated to the contrary by the context of usage, where an embodiment of the subject matter hereof is stated or described as comprising, including, containing, having, being composed of or being constituted by or of certain features or elements, one or more features or elements in addition to those explicitly stated or described may be present in the embodiment. For example, a process, method, article, or apparatus that comprises a list of elements is not necessarily limited to only those elements but may include other elements not expressly listed or inherent to such process, method, article, or apparatus. An alternative embodiment of the disclosed subject matter hereof, is described as consisting essentially of certain features or elements, in which embodiment features or elements that would materially alter the principle of operation or the distinguishing characteristics of the embodiment are not present therein. A further alternative embodiment of the described subject matter hereof is described as consisting of certain features or elements, in which embodiment, or in insubstantial variations thereof, only the features or elements specifically stated or described are present.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Group numbers corresponding to columns within the Periodic Table of the elements use the “New Notation” convention as seen in the CRC Handbook of Chemistry and Physics, 81^{st} Edition (2000-2001).

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

To the extent not described herein, many details regarding specific materials, processing acts, and circuits are conventional and may be found in textbooks and other sources within the organic light-emitting diode display, photodetector, photovoltaic, and semiconductive member arts.

### 2. ADDITIVE

The additive is a compound having Formula I

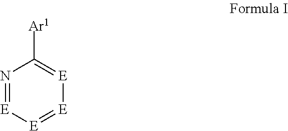

wherein:
E is the same or different at each occurrence and is N or C—Ar¹, with the proviso that at least one E=N; and
Ar¹ is the same or different at each occurrence and is H, D, or aryl, with the proviso that at least one Ar¹ is aryl.

In some embodiments, the compounds having Formula I are useful as electron-trapping materials. Electron-trapping materials such as C60 have been added to standard blue emissive systems to try to decrease electron flow in the blue sub-pixel stack. However, such materials have all suffered from a strong quenching of the blue or green excitons leading to drops in quantum efficiency which are unacceptable. A material having a deep LUMO (strong electron trap) which is not a quencher for the blue or green photons is desired.

In some embodiments, the compounds having Formula I have a LUMO level deeper than −2.0 eV; in some embodiments, deeper than −2.2 eV; in some embodiments, deeper than −2.4 eV.

In some embodiments, the compounds having Formula I have a band gap of at least 2.9 eV; in some embodiments, at least 3.0 eV; in some embodiments, at least 3.1 eV.

In some embodiments, the compounds having Formula I have a first excited state singlet energy greater than 2.8 eV; in some embodiments, greater than 2.9 eV; in some embodiments, greater than 3.0 eV. Such materials may be useful as electron-trapping materials for fluorescent emitters of all colors without quenching such emission.

In some embodiments, the compound having Formula I have a first excited triplet energy greater than 2.1 eV. Such materials may be useful as electron-trapping materials for emitters having red color and emitting from a triplet or mixed singlet-triplet state.

In some embodiments, the compound having Formula I have a first excited triplet energy greater than 2.5 eV. Such materials may be useful as electron-trapping materials for emitters having red or green color and emitting from a triplet or mixed singlet-triplet state.

In some embodiments, the compound having Formula I have a first excited triplet energy greater than 2.65 eV. Such materials may be useful as electron-trapping materials for emitters having red, green, or blue-green color and emitting from a triplet or mixed singlet-triplet state.

In some embodiments, the compound having Formula I have a first excited triplet energy greater than 2.85 eV. Such materials may be useful as electron-trapping materials for emitters having red, green, or blue color and emitting from a triplet or mixed singlet-triplet state.

In some embodiments, the compound having Formula I is deuterated. In some embodiments, the compound is at least 10% deuterated; in some embodiments, at least 20% deuterated; in some embodiments, at least 30% deuterated; in some embodiments, at least 40% deuterated; in some embodiments, at least 50% deuterated; in some embodiments, at least 60% deuterated; in some embodiments, at least 70% deuterated; in some embodiments, at least 80% deuterated; in some embodiments, at least 90% deuterated. In some embodiments, the host is 100% deuterated.

In some embodiments of Formula I, one or two of E are N.

In some embodiments of Formula I, at least one Ar¹ has at least one substituent which is an electron-withdrawing group (“EWG”). In some embodiments, the EWG is fluoro, cyano, nitro, —SO₂R, where R is alkyl or perfluoroalkyl, or deuterated analogs thereof.

In some embodiments, at least one Ar¹ is selected from the group consisting of phenyl, biphenyl, naphthyl, binaphthyl, phenylnaphthyl, naphthylphenyl, carbazolylphenyl, diarylaminophenyl, substituted derivatives thereof, and deuterated analogs thereof. In some embodiments, the substituted derivative has a substituent selected from the group consisting of alkyl, aryl, alkoxy, silyl, siloxane, and deuterated analogs thereof.

In some embodiments, Ar¹ is a hydrocarbon aryl. In some embodiments, Ar¹ is selected from the group consisting of phenyl, biphenyl, naphthyl, binaphthyl, phenylnaphthyl, naphthylphenyl, substituted derivatives thereof, and deuterated analogs thereof, where there is at least one substituent which is an EWG.

In some embodiments, the compound of Formula I is further described by Formula II

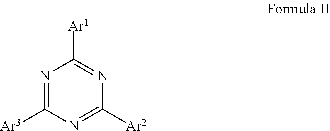

wherein:
Ar¹-Ar³ are the same or different and are H, D, or aryl, with the proviso that at least one of Ar¹-Ar³ is aryl.

In some embodiments of Formula II, one of Ar¹-Ar³ is aryl and the other Ar groups are H or D. In some embodiments, two of Ar¹-Ar³ are aryl and the other Ar group is H or D. In some embodiments, each of Ar¹-Ar³ is aryl.

In some embodiments of Formula II, Ar¹ is selected from the group consisting of phenyl, biphenyl, naphthyl, binaphthyl, phenylnaphthyl, naphthylphenyl, a substituted derivative thereof, and a deuterated analog thereof.

In some embodiments of Formula II, at least one of Ar¹-Ar³ is an aryl having an EWG. In some embodiments, two of Ar¹-Ar³ are an aryl having an EWG. In some embodiments, each of Ar¹-Ar³ are an aryl having an EWG.

In some embodiments of Formula II, at least one of Ar¹-Ar³ is selected from the group consisting of phenyl, biphenyl, naphthyl, binaphthyl, phenylnaphthyl, naphthylphenyl, carbazolylphenyl, diarylaminophenyl, substituted derivatives thereof, and deuterated analogs thereof. In some embodiments, the substituted derivative has a substituent selected from the group consisting of alkyl, aryl, alkoxy, silyl, siloxane, and deuterated analogs thereof.

In some embodiments, the compound of Formula I is further described by Formula III

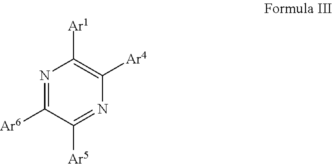

wherein:
Ar¹ and Ar⁴-Ar⁶ are the same or different and are H, D, or aryl, with the proviso that at least one of Ar¹ and Ar⁴-Ar⁶ is aryl.

In some embodiments of Formula III, one of Ar¹ and Ar⁴-Ar⁶ is aryl and the other Ar groups are H or D. In some embodiments, two of Ar¹ and Ar⁴-Ar⁶ are aryl and the other Ar groups are H or D. In some embodiments, three of Ar¹ and Ar⁴-Ar⁶ are aryl and the other Ar group is H or D. In some embodiments, each of Ar¹ and Ar⁴-Ar⁶ is aryl.

In some embodiments of Formula III, Ar¹ is selected from the group consisting of phenyl, biphenyl, naphthyl, binaphthyl, phenylnaphthyl, naphthylphenyl, a substituted derivative thereof, and a deuterated analog thereof.

In some embodiments of Formula III, at least one of Ar¹ and Ar⁴-Ar⁶ is an aryl having an EWG. In some embodiments, two of Ar¹ and Ar⁴-Ar⁶ are an aryl having an EWG. In some embodiments, each of Ar¹-Ar³ are an aryl having an EWG.

In some embodiments of Formula III, at least one of Ar¹ and Ar⁴-Ar⁶ is selected from the group consisting of phenyl, biphenyl, naphthyl, binaphthyl, phenylnaphthyl, naphthylphenyl, carbazolylphenyl, diarylaminophenyl, substituted derivatives thereof, and deuterated analogs thereof. In some embodiments, the substituted derivative has a substituent selected from the group consisting of alkyl, aryl, alkoxy, silyl, siloxane, and deuterated analogs thereof.

Some examples of compounds having Formula I include, but are not limited to those given below.

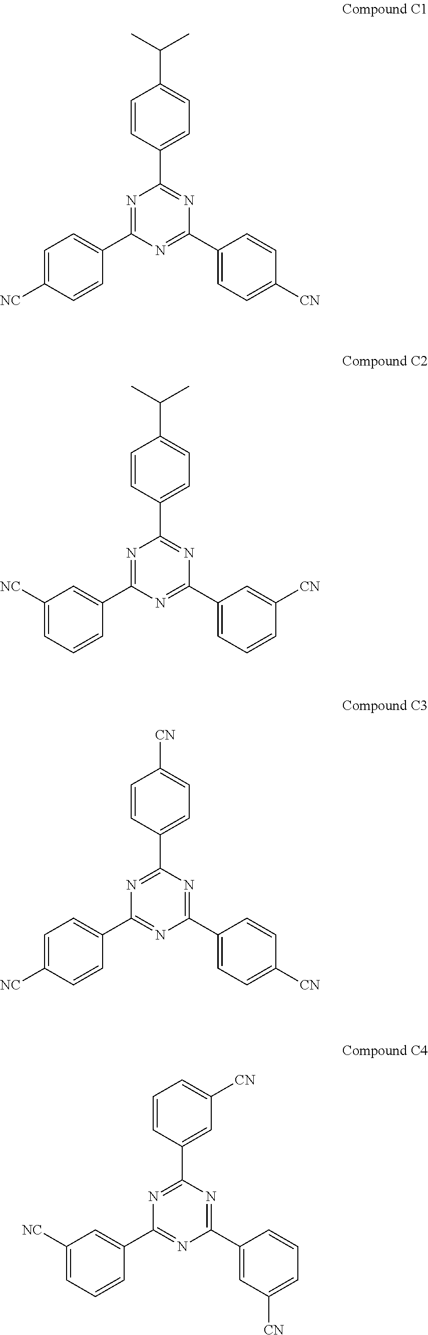 [SMILES: CC(C)c1ccc(-c2nc(-c3ccc(C#N)cc3)nc(-c3ccc(C#N)cc3)n2)cc1 ; CC(C)c1ccc(-c2nc(-c3cccc(C#N)c3)nc(-c3cccc(C#N)c3)n2)cc1 ; N#Cc1ccc(-c2nc(-c3ccc(C#N)cc3)nc(-c3ccc(C#N)cc3)n2)cc1 ; N#Cc1cccc(-c2nc(-c3cccc(C#N)c3)nc(-c3cccc(C#N)c3)n2)c1]

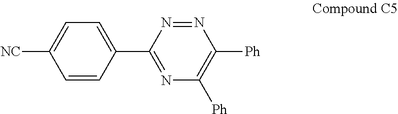 [SMILES: N#Cc1ccc(-c2nnc(-c3ccccc3)c(-c3ccccc3)n2)cc1]

where “Ph” indicates a phenyl group.

The HOMO, LUMO, band gap, singlet and triplet energies were calculated and are given in Table 1 below. All calculations were performed with the density functional theory (DFT) methods within the Gaussian 03 suite of programs (Gaussian 03, revision D.01; Gaussian, Inc., Wallingford, Conn., 2004). The molecular structures were first optimized at the BP86/6-31G+IrMWB60 level and then used in subsequent analytic vibrational frequency calculations at this same level of computation to ensure that these structures were indeed equilibrium ones. For the excited-state calculations, previous experience has shown that time-dependent DFT (TDDFT) at the B3LYP/6-31G+IrMWB60 level is satisfactory in computing the first seven singlet and triplet energy transitions. In order to obtain HOMO and LUMO values for these molecules, the B3LYP/6-31+G(d)+IrMWB60 level was used.

TABLE 1
Energy Calculations

| | HOMO | LUMO | Band Gap | 1^{st} Singlet | 1^{st} Triplet |
|---|---|---|---|---|---|
| Comp. | (eV) | (eV) | (eV) | (eV) | (eV) |
| C1 | −7.10 | −3.12 | 3.98 | 3.50 | 2.66 |
| | | | | (355 nm) | (466 nm) |
| C2 | −7.04 | −2.86 | 4.18 | 3.65 | 2.78 |
| | | | | (339 nm) | (446 nm) |
| C3 | −7.73 | −3.44 | 4.29 | 3.61 | 2.61 |
| | | | | (344 nm) | (475 nm) |
| C4 | −7.75 | −3.18 | 4.57 | 3.82 | 2.80 |
| | | | | (324 nm) | (443 nm) |
| C5 | −6.62 | −2.83 | 3.80 | 2.94 | 2.18 |
| | | | | (422 nm) | (568 nm) |

### 3. ELECTROACTIVE COMPOSITION

The new electroactive composition comprises (a) a host, (b) a dopant, and (c) an additive having Formula I, as described above. In some embodiments, the host is present in the range of 50-95% by weight, based on the total weight of the electroactive composition; the dopant is present in the range of 3-10% by weight, based on the total weight of the electroactive composition; and the compound having Formula I is present in the range of 0.001-10% by weight, based on the total weight of the electroactive composition.

In some embodiments, the electroactive composition further comprises (d) a second host. In some embodiments, the weight ratio of the first host (a) to the second host (d) is in the range of 19:1 to 1:19; in some embodiments, 9:1 to 1:9.

### (a) Host

In some embodiments, the host is deuterated. In some embodiments, the host is at least 10% deuterated; in some embodiments, at least 20% deuterated; in some embodiments, at least 30% deuterated; in some embodiments, at least 40% deuterated; in some embodiments, at least 50% deuterated; in some embodiments, at least 60% deuterated; in some embodiments, at least 70% deuterated; in some embodiments, at least 80% deuterated; in some embodiments, at least 90% deuterated. In some embodiments, the host is 100% deuterated.

Examples of host materials include, but are not limited to, carbazoles, indolocarbazoles, chrysenes, phenanthrenes, triphenylenes, phenanthrolines, triazines, naphthalenes, anthracenes, quinolines, isoquinolines, quinoxalines, phenylpyridines, benzodifurans, metal quinolinate complexes, and deuterated analogs thereof.

In some embodiments, the host is a polycyclic aromatic having one or more aryl substituents. In some embodiments, the polycyclic aromatic is selected from the group consisting of indolocarbazoles, chrysenes, phenanthrenes, triphenylenes, phenanthrolines, triazines, naphthalenes, anthracenes, quinolines, isoquinolines, quinoxalines, phenylpyridines, benzodifurans, and deuterated analogs thereof.

In some embodiments, the host material has Formula IV:

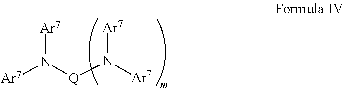

where:
Ar⁷ is the same or different at each occurrence and is aryl;
Q is selected from the group consisting of multivalent aryl groups and

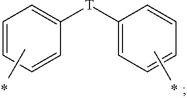

T is selected from the group consisting of (CR′)_{g}, SiR₂, S, SO₂, PR, PO, PO₂, BR, and R;
R is the same or different at each occurrence and is selected from the group consisting of alkyl, aryl, silyl, or a deuterated analog thereof;
R′ is the same or different at each occurrence and is selected from the group consisting of H, D, alkyl and silyl;
g is an integer from 1-6; and
m is an integer from 0-6.

In some embodiments of Formula IV, adjacent Ar⁷ groups are joined together to form rings such as carbazole. In Formula IV, “adjacent” means that the Ar groups are bonded to the same N.

In some embodiments, the Ar⁷ groups are independently selected from the group consisting of phenyl, biphenyl, terphenyl, quaterphenyl, naphthyl, phenanthryl, naphthylphenyl, phenanthrylphenyl, and deuterated analogs thereof. Analogs higher than quaterphenyl can also be used, having 5-10 phenyl rings.

In some embodiments, at least one Ar⁷ has at least one substituent. Substituent groups can be present in order to alter the physical or electronic properties of the host material. In some embodiments, the substituents improve the processibility of the host material. In some embodiments, the substituents increase the solubility and/or increase the Tg of the host material. In some embodiments, the substituents are selected from the group consisting of alkyl groups, alkoxy groups, silyl groups, deuterated analogs thereof, and combinations thereof.

In some embodiments, Q is an aryl group having at least two fused rings. In some embodiments, Q has 3-5 fused aromatic rings. In some embodiments, Q is selected from the group consisting of chrysene, phenanthrene, triphenylene, phenanthroline, naphthalene, anthracene, quinoline, isoquinoline, and deuterated analogs thereof.

### (b) Dopant

Emissive dopant materials include small molecule organic fluorescent compounds, luminescent metal complexes, and mixtures thereof. Examples of fluorescent compounds include, but are not limited to, pyrene, perylene, rubrene, coumarin, derivatives thereof, and mixtures thereof. Examples of metal complexes include, but are not limited to, metal chelated oxinoid compounds, such as tris(8-hydroxyquinolato)aluminum (AIQ); cyclometalated iridium and platinum electroluminescent compounds, such as complexes of iridium with phenylpyridine, phenylquinoline, phenylisoquinoline or phenylpyrimidine ligands as disclosed in Petrov et al., U.S. Pat. No. 6,670,645 and Published PCT Applications WO 03/063555 and WO 2004/016710, and organometallic complexes described in, for example, Published PCT Applications WO 03/008424, WO 03/091688, and WO 03/040257, and mixtures thereof.

In some embodiments, the emissive dopant is an organometallic complex. In some embodiments, the emissive dopant is an organometallic complex of iridium. In some embodiments, the organometallic complex is cyclometallated. By “cyclometallated” it is meant that the complex contains at least one ligand which bonds to the metal in at least two points, forming at least one 5- or 6-membered ring with at least one carbon-metal bond. In some embodiments, the organometallic Ir complex is electrically neutral and is a tris-cyclometallated complex having the formula IrL₃ or a bis-cyclometallated complex having the formula IrL₂Y. In some embodiments, L is a monoanionic bidentate cyclometalating ligand coordinated through a carbon atom and a nitrogen atom. In some embodiments, L is an aryl N-heterocycle, where the aryl is phenyl or napthyl, and the N-heterocycle is pyridine, quinoline, isoquinoline, diazine, pyrrole, pyrazole or imidazole. In some embodiments, Y is a monoanionic bidentate ligand. In some embodiments, L is a phenylpyridine, a phenylquinoline, or a phenylisoquinoline. In some embodiments, Y is a β-dienolate, a diketimine, a picolinate, or an N-alkoxypyrazole. The ligands may be unsubstituted or substituted with F, D, alkyl, perfluororalkyl, alkoxyl, alkylamino, arylamino, CN, silyl, fluoroalkoxyl or aryl groups.

In some embodiments, the emissive dopant is selected from the group consisting of a non-polymeric spirobifluorene compound and a fluoranthene compound.

In some embodiments, the emissive dopant is a compound having aryl amine groups. In some embodiments, the emissive dopant is selected from the formulae below:

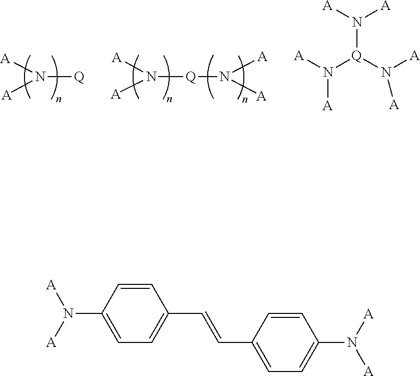

where:

A is the same or different at each occurrence and is an aromatic group having from 3-60 carbon atoms;

Q is a single bond or an aromatic group having from 3-60 carbon atoms;

n and m are independently an integer from 1-6.

In some embodiments of the above formula, at least one of A and Q in each formula has at least three condensed rings. In some embodiments, m and n are equal to 1.

In some embodiments, Q is a styryl or styrylphenyl group.

In some embodiments, Q is an aromatic group having at least two condensed rings. In some embodiments, Q is selected from the group consisting of naphthalene, anthracene, chrysene, pyrene, tetracene, xanthene, perylene, coumarin, rhodamine, quinacridone, and rubrene.

In some embodiments, A is selected from the group consisting of phenyl, tolyl, naphthyl, and anthracenyl groups.

In some embodiments, the emissive dopant has the formula below:

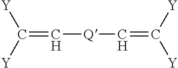

where:

Y is the same or different at each occurrence and is an aromatic group having 3-60 carbon atoms;

Q′ is an aromatic group, a divalent triphenylamine residue group, or a single bond.

In some embodiments, the emissive dopant is an aryl acene. In some embodiments, the emissive dopant is a non-symmetrical aryl acene.

In some embodiments, the emissive dopant is a chrysene derivative. The term “chrysene” is intended to mean 1,2-benzophenanthrene. In some embodiments, the emissive dopant is a chrysene having aryl substituents. In some embodiments, the emissive dopant is a chrysene having arylamino substituents. In some embodiments, the emissive dopant is a chrysene having two different arylamino substituents. In some embodiments, the chrysene derivative has a deep blue emission.

In some embodiments, separate photoactive compositions with different dopants are used to provide different colors. In some embodiments, the dopants are selected to have red, green, and blue emission. As used herein, red refers to light having a wavelength maximum in the range of 600-700 nm; green refers to light having a wavelength maximum in the range of 500-600 nm; and blue refers to light having a wavelength maximum in the range of 400-500 nm.

Examples of blue light-emitting materials include, but are not limited to, diarylanthracenes, diaminochrysenes, diaminopyrenes, cyclometalated complexes of Ir having phenylpyridine ligands, and polyfluorene polymers. Blue light-emitting materials have been disclosed in, for example, U.S. Pat. No. 6,875,524, and published US applications 2007-0292713 and 2007-0063638.

Examples of red light-emitting materials include, but are not limited to, cyclometalated complexes of Ir having phenylquinoline or phenylisoquinoline ligands, periflanthenes, fluoranthenes, and perylenes. Red light-emitting materials have been disclosed in, for example, U.S. Pat. No. 6,875,524, and published US application 2005-0158577.

Examples of green light-emitting materials include, but are not limited to, cyclometalated complexes of Ir having phenylpyridine ligands, diaminoanthracenes, and polyphenylenevinylene polymers. Green light-emitting materials have been disclosed in, for example, published PCT application WO 2007/021117.

Examples of dopant materials include, but are not limited to, compounds B1 to B11 below.

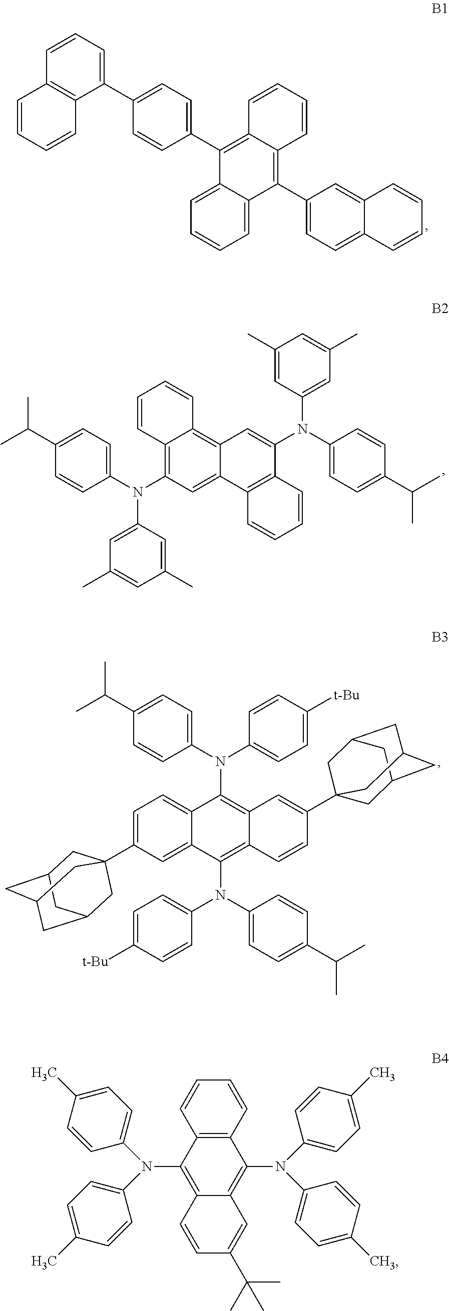

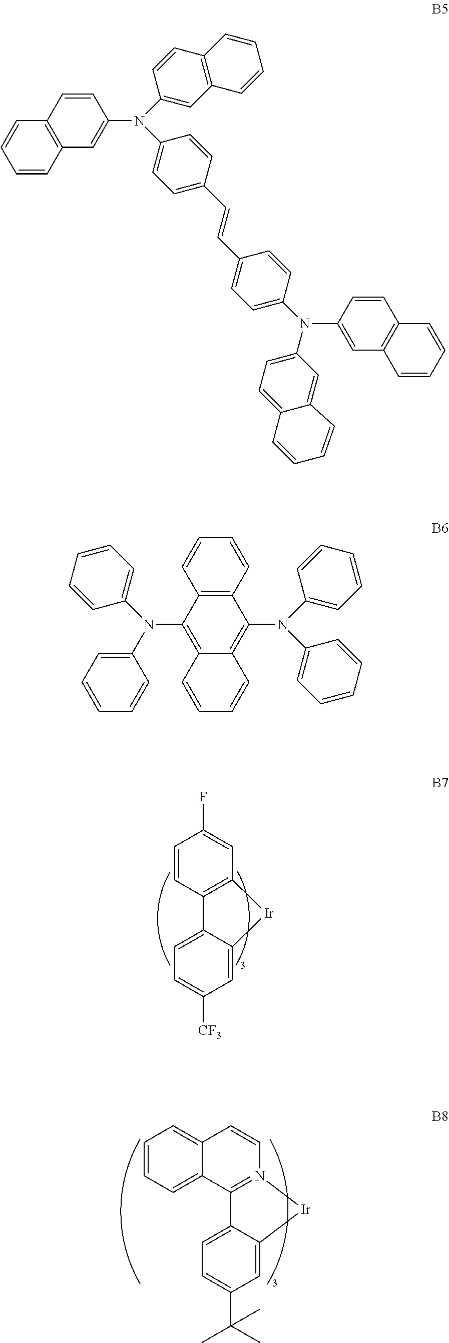

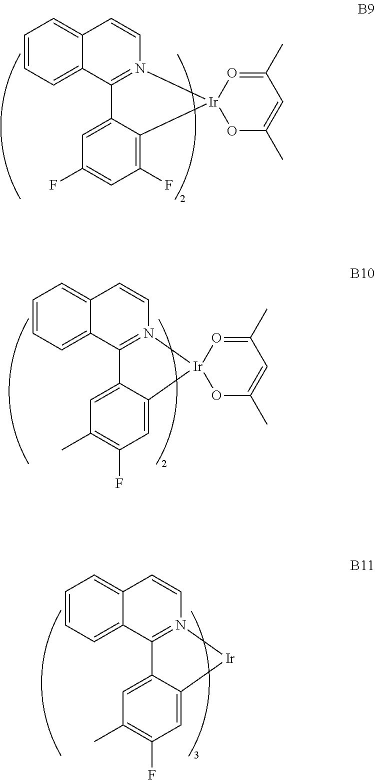

### (c) Additive

The additive is as discussed above.

### (d) Optional Second Host

In some embodiments, two hosts are present. In some embodiments, the first host (a) facilitates hole transport faster than electron transport and is referred to as a hole-transporting host; and the second host (d) facilitates electron transport faster than hole transport and is referred to as an electron-transporting host.

In some embodiments, the hole-transporting first host has Formula IV where Q is chrysene, phenanthrene, triphenylene, phenanthrolene, naphthalene, anthracene, quinoline, or isoquinoline. In some embodiments, the electron-transporting second host is a phenanthroline, a quinoxaline, a phenylpyridine, a benzodifuran, or a metal quinolinate complex.

### 4. DEVICES

Organic electronic devices that may benefit from having one or more layers comprising the electroactive materials described herein include, but are not limited to, (1) devices that convert electrical energy into radiation (e.g., a light-emitting diode, light emitting diode display, lighting device, luminaire, or diode laser), (2) devices that detect signals through electronics processes (e.g., photodetectors, photoconductive cells, photoresistors, photoswitches, phototransistors, phototubes, IR detectors, biosensors), (3) devices that convert radiation into electrical energy, (e.g., a photovoltaic device or solar cell), and (4) devices that include one or more electronic components that include one or more organic semi-conductor layers (e.g., a transistor or diode).

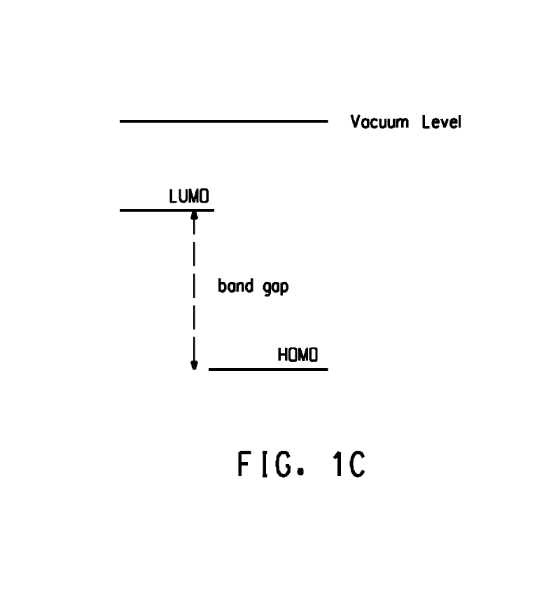

One illustration of an organic electronic device structure is shown in FIG. 2. The device 100 has a first electrical contact layer, an anode layer 110 and a second electrical contact layer, a cathode layer 160, and a photoactive layer 140 between them. Adjacent to the anode is a hole injection layer 120. Adjacent to the hole injection layer is a hole transport layer 130, comprising hole transport material. Adjacent to the cathode may be an electron transport layer 150, comprising an electron transport material. As an option, devices may use one or more additional hole injection or hole transport layers (not shown) next to the anode 110 and/or one or more additional electron injection or electron transport layers (not shown) next to the cathode 160.

Layers 120 through 150 are individually and collectively referred to as the active layers.

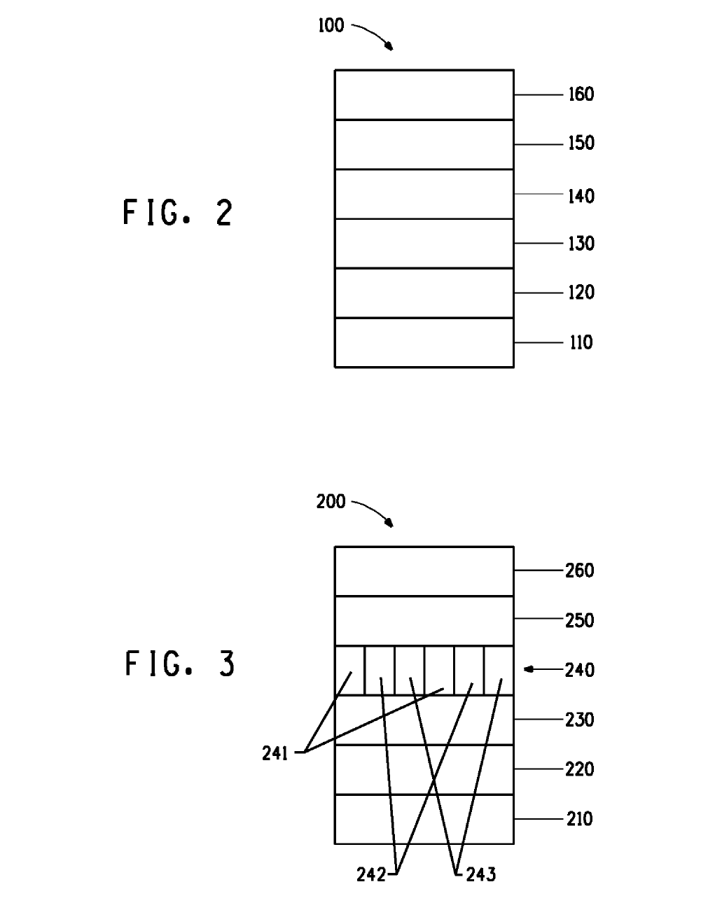

In some embodiments, the photoactive layer is pixellated, as shown in FIG. 3. In device 200, layer 140 is divided into pixel or subpixel units 141, 142, and 143 which are repeated over the layer. Each of the pixel or subpixel units represents a different color. In some embodiments, the subpixel units are for red, green, and blue. Although three subpixel units are shown in the figure, two, or more than three may be used.

In one embodiment, the different layers have the following range of thicknesses: anode 110, 500-5000 Å, in one embodiment 1000-2000 Å; hole injection layer 120, 50-2000 Å, in one embodiment 200-1000 Å; hole transport layer 120, 50-2000 Å, in one embodiment 200-1000 Å; photoactive layer 130, 10-2000 Å, in one embodiment 100-1000 Å; layer 140, 50-2000 Å, in one embodiment 100-1000 Å; cathode 150, 200-10000 Å, in one embodiment 300-5000 Å. The location of the electron-hole recombination zone in the device, and thus the emission spectrum of the device, can be affected by the relative thickness of each layer. The desired ratio of layer thicknesses will depend on the exact nature of the materials used.

In some embodiments, the organic electronic device comprises a first electrical contact, a second electrical contact and a photoactive layer therebetween, wherein the photoactive layer comprises the above electroactive composition.

In some embodiments, the compounds having Formula I are useful as electron-trapping materials in photoactive layer 140.

a. Photoactive Layer

In some embodiments, the photoactive layer comprises the electroactive layer described above. In some embodiments, the photoactive layer consists essentially of (a) a host, (b) a dopant, and (c) an additive having Formula I. In some embodiments, the photoactive layer consists essentially of (a) a host, (b) a dopant, (c) an additive having Formula I, and (d) a second host. The weight ratio of dopant to total host material is in the range of 5:95 to 70:30; in some embodiments, 90:10 to 80:20.

b. Other Device Layers

The other layers in the device can be made of any materials which are known to be useful in such layers.

The anode 110 is an electrode that is particularly efficient for injecting positive charge carriers. It can be made of, for example materials containing a metal, mixed metal, alloy, metal oxide or mixed-metal oxide, or it can be a conducting polymer, and mixtures thereof. Suitable metals include the Group 11 metals, the metals in Groups 4, 5, and 6, and the Group 8-10 transition metals. If the anode is to be light-transmitting, mixed-metal oxides of Groups 12, 13 and 14 metals, such as indium-tin-oxide, are generally used. The anode may also comprise an organic material such as polyaniline as described in “Flexible light-emitting diodes made from soluble conducting polymer,” Nature vol. 357, pp 477 479 (11 Jun. 1992). At least one of the anode and cathode should be at least partially transparent to allow the generated light to be observed.

The hole injection layer 120 comprises hole injection material and may have one or more functions in an organic electronic device, including but not limited to, planarization of the underlying layer, charge transport and/or charge injection properties, scavenging of impurities such as oxygen or metal ions, and other aspects to facilitate or to improve the performance of the organic electronic device. The hole injection layer can be formed with polymeric materials, such as polyaniline (PANI) or polyethylenedioxythiophene (PEDOT), which are often doped with protonic acids. The protonic acids can be, for example, poly(styrenesulfonic acid), poly(2-acrylamido-2-methyl-1-propanesulfonic acid), and the like.

The hole injection layer can comprise charge transfer compounds, and the like, such as copper phthalocyanine and the tetrathiafulvalene-tetracyanoquinodimethane system (TTF-TCNQ).

In some embodiments, the hole injection layer comprises at least one electrically conductive polymer and at least one fluorinated acid polymer.

In some embodiments, the hole injection layer is made from an aqueous dispersion of an electrically conducting polymer doped with a colloid-forming polymeric acid. Such materials have been described in, for example, published U.S. patent applications US 2004/0102577, US 2004/0127637, US 2005/0205860, and published PCT application WO 2009/018009.

Examples of hole transport materials for layer 130 have been summarized for example, in Kirk-Othmer Encyclopedia of Chemical Technology, Fourth Edition, Vol. 18, p. 837-860, 1996, by Y. Wang. Both hole transporting molecules and polymers can be used. Commonly used hole transporting molecules are: N,N′-diphenyl-N,N′-bis(3-methylphenyl)-[1,1′-biphenyl]-4,4′-diamine (TPD), 1,1-bis[(di-4-tolylamino) phenyl]cyclohexane (TAPC), N,N′-bis(4-methylphenyl)-N,N′-bis(4-ethylphenyl)-[1,1′-(3,3′-dimethyl)biphenyl]-4,4′-diamine (ETPD), tetrakis-(3-methylphenyl)-N,N,N′,N′-2,5-phenylenediamine (PDA), a-phenyl-4-N,N-diphenylaminostyrene (TPS), p-(diethylamino)benzaldehyde diphenylhydrazone (DEH), triphenylamine (TPA), bis[4-(N,N-diethylamino)-2-methylphenyl](4-methylphenyl)methane (MPMP), 1-phenyl-3-[p-(diethylamino)styryl]-5-[p-(diethylamino)phenyl]pyrazoline (PPR or DEASP), 1,2-trans-bis(9H-carbazol-9-yl)cyclobutane (DCZB), N,N,N′,N′-tetrakis(4-methylphenyl)-(1,1′-biphenyl)-4,4′-diamine (TTB), N,N′-bis(naphthalen-1-yl)-N,N′-bis-(phenyl)benzidine (—NPB), and porphyrinic compounds, such as copper phthalocyanine. In some embodiments, the hole transport layer comprises a hole transport polymer. In some embodiments, the hole transport polymer is a distyrylaryl compound. In some embodiments, the aryl group has two or more fused aromatic rings. In some embodiments, the aryl group is an acene. The term “acene” as used herein refers to a hydrocarbon parent component that contains two or more ortho-fused benzene rings in a straight linear arrangement. Other commonly used hole transporting polymers are polyvinylcarbazole, (phenylmethyl)-polysilane, and polyaniline. It is also possible to obtain hole transporting polymers by doping hole transporting molecules such as those mentioned above into polymers such as polystyrene and polycarbonate. In some cases, triarylamine polymers are used, especially triarylamine-fluorene copolymers. In some cases, the polymers and copolymers are crosslinkable.

In some embodiments, the hole transport layer further comprises a p-dopant. In some embodiments, the hole transport layer is doped with a p-dopant. Examples of p-dopants include, but are not limited to, tetrafluorotetracyanoquinodimethane (F4-TCNQ) and perylene-3,4,9,10-tetracarboxylic-3,4,9,10-dianhydride (PTCDA).

Examples of electron transport materials which can be used for layer 150 include, but are not limited to, metal chelated oxinoid compounds, including metal quinolate derivatives such as tris(8-hydroxyquinolato)aluminum (AIQ), bis(2-methyl-8-quinolinolato)(p-phenylphenolato) aluminum (BAIq), tetrakis-(8-hydroxyquinolato)hafnium (HfQ) and tetrakis-(8-hydroxyquinolato)zirconium (ZrQ); and azole compounds such as 2-(4-biphenylyl)-5-(4-t-butylphenyl)-1,3,4-oxadiazole (PBD), 3-(4-biphenylyl)-4-phenyl-5-(4-t-butylphenyl)-1,2,4-triazole (TAZ), and 1,3,5-tri(phenyl-2-benzimidazole)benzene (TPBI); quinoxaline derivatives such as 2,3-bis(4-fluorophenyl)quinoxaline; phenanthrolines such as 4,7-diphenyl-1,10-phenanthroline (DPA) and 2,9-dimethyl-4,7-diphenyl-1,10-phenanthroline (DDPA); and mixtures thereof. In some embodiments, the electron transport layer further comprises an n-dopant. N-dopant materials are well known. The n-dopants include, but are not limited to, Group 1 and 2 metals; Group 1 and 2 metal salts, such as LiF, CsF, and Cs₂CO₃; Group 1 and 2 metal organic compounds, such as Li quinolate; and molecular n-dopants, such as leuco dyes, metal complexes, such as W₂(hpp)₄ where hpp=1,3,4,6,7,8-hexahydro-2H-pyrimido-[1,2-a]-pyrimidine and cobaltocene, tetrathianaphthacene, bis(ethylenedithio)tetrathiafulvalene, heterocyclic radicals or diradicals, and the dimers, oligomers, polymers, dispiro compounds and polycycles of heterocyclic radical or diradicals.

The cathode 160, is an electrode that is particularly efficient for injecting electrons or negative charge carriers. The cathode can be any metal or nonmetal having a lower work function than the anode. Materials for the cathode can be selected from alkali metals of Group 1 (e.g., Li, Cs), the Group 2 (alkaline earth) metals, the Group 12 metals, including the rare earth elements and lanthanides, and the actinides. Materials such as aluminum, indium, calcium, barium, samarium and magnesium, as well as combinations, can be used.

Alkali metal-containing inorganic compounds, such as LiF, CsF, Cs₂O and Li₂O, or Li-containing organometallic compounds can also be deposited between the organic layer 150 and the cathode layer 160 to lower the operating voltage. This layer, not shown, may be referred to as an electron injection layer.

It is known to have other layers in organic electronic devices. For example, there can be a layer (not shown) between the anode 110 and hole injection layer 120 to control the amount of positive charge injected and/or to provide band-gap matching of the layers, or to function as a protective layer. Layers that are known in the art can be used, such as copper phthalocyanine, silicon oxy-nitride, fluorocarbons, silanes, or an ultra-thin layer of a metal, such as Pt. Alternatively, some or all of anode layer 110, active layers 120, 130, 140, and 150, or cathode layer 160, can be surface-treated to increase charge carrier transport efficiency. The choice of materials for each of the component layers is preferably determined by balancing the positive and negative charges in the emitter layer to provide a device with high electroluminescence efficiency.

It is understood that each functional layer can be made up of more than one layer.

c. Device Fabrication

The device layers can be formed by any deposition technique, or combinations of techniques, including vapor deposition, liquid deposition, and thermal transfer.

In some embodiments, the device is fabricated by liquid deposition of the hole injection layer, the hole transport layer, and the photoactive layer, and by vapor deposition of the anode, the electron transport layer, an electron injection layer and the cathode.

The hole injection layer can be deposited from any liquid medium in which it is dissolved or dispersed and from which it will form a film. In one embodiment, the liquid medium consists essentially of one or more organic solvents. In one embodiment, the liquid medium consists essentially of water or water and an organic solvent. The hole injection material can be present in the liquid medium in an amount from 0.5 to 10 percent by weight. The hole injection layer can be applied by any continuous or discontinuous liquid deposition technique. In one embodiment, the hole injection layer is applied by spin coating. In one embodiment, the hole injection layer is applied by ink jet printing. In one embodiment, the hole injection layer is applied by continuous nozzle printing. In one embodiment, the hole injection layer is applied by slot-die coating. After liquid deposition, the liquid medium can be removed in air, in an inert atmosphere, or by vacuum, at room temperature or with heating.

The hole transport layer can be deposited from any liquid medium in which it is dissolved or dispersed and from which it will form a film. In one embodiment, the liquid medium consists essentially of one or more organic solvents. In one embodiment, the liquid medium consists essentially of water or water and an organic solvent. In one embodiment the organic solvent is an aromatic solvent. In one embodiment, the organic liquid is selected from chloroform, dichloromethane, chlorobenzene, dichlorobenzene, toluene, xylene, mesitylene, anisole, and mixtures thereof. The hole transport material can be present in the liquid medium in a concentration of 0.2 to 2 percent by weight. The hole transport layer can be applied by any continuous or discontinuous liquid deposition technique. In one embodiment, the hole transport layer is applied by spin coating. In one embodiment, the hole transport layer is applied by ink jet printing. In one embodiment, the hole transport layer is applied by continuous nozzle printing. In one embodiment, the hole transport layer is applied by slot-die coating. After liquid deposition, the liquid medium can be removed in air, in an inert atmosphere, or by vacuum, at room temperature or with heating.

The photoactive layer can be deposited from any liquid medium in which it is dissolved or dispersed and from which it will form a film. In one embodiment, the liquid medium consists essentially of one or more organic solvents. In one embodiment, the liquid medium consists essentially of water or water and an organic solvent. In one embodiment the organic solvent is an aromatic solvent. In one embodiment, the organic solvent is selected from chloroform, dichloromethane, toluene, anisole, 2-butanone, 3-pentanone, butyl acetate, acetone, xylene, mesitylene, chlorobenzene, tetrahydrofuran, diethyl ether, trifluorotoluene, and mixtures thereof. The photoactive material can be present in the liquid medium in a concentration of 0.2 to 2 percent by weight. Other weight percentages of photoactive material may be used depending upon the liquid medium. The photoactive layer can be applied by any continuous or discontinuous liquid deposition technique. In one embodiment, the photoactive layer is applied by spin coating. In one embodiment, the photoactive layer is applied by ink jet printing. In one embodiment, the photoactive layer is applied by continuous nozzle printing. In one embodiment, the photoactive layer is applied by slot-die coating. After liquid deposition, the liquid medium can be removed in air, in an inert atmosphere, or by vacuum, at room temperature or with heating.

The electron transport layer can be deposited by any vapor deposition method. In one embodiment, it is deposited by thermal evaporation under vacuum.

The electron injection layer can be deposited by any vapor deposition method. In one embodiment, it is deposited by thermal evaporation under vacuum.

The cathode can be deposited by any vapor deposition method. In one embodiment, it is deposited by thermal evaporation under vacuum.

### EXAMPLES

The concepts described herein will be further described in the following examples, which do not limit the scope of the invention described in the claims.

### Example 1

This example illustrates the preparation of Compound C1, (4,4′-(6-(4-isopropylphenyl)-1,3,5-triazine-2,4-diyl)dibenzonitrile).

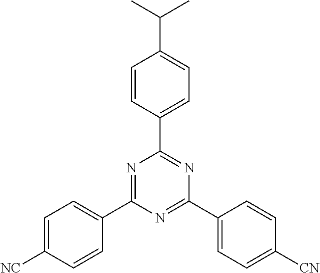 [SMILES: CC(C)c1ccc(-c2nc(-c3ccc(C#N)cc3)nc(-c3ccc(C#N)cc3)n2)cc1]

### a. 2,4-Dichloro-6-(4-isopropylphenyl)-1,3,5-triazine

In a drybox, a three-neck 250 ml round-bottom flask was charged with cyanuric chloride (1.84 g, 10 mmol) and anhydrous THF (50 ml). A one-neck 50 ml round-bottom flask was charged with MgBr₂.OEt₂ (2.58 g, 10 mmol) and anhydrous THF (22 ml). 4-iso-Propylbromobenzene (1.99 g, 10 mmol) was dissolved in 20 ml of anhydrous THF in a 100 ml three-neck round-bottom flask, also in the drybox. All three flasks were capped, taken out of the box and attached to a vacuum line. The flask with the aryl bromide solution was cooled to −78° C. and a solution of n-butyl lithium (8 ml, 20 mmol, 2.5 M in hexanes) was added dropwise by a syringe (syringe lock used). Temperature of the mixture was kept below −70° C. during the addition. Cold bath was removed and solution was allowed to warm to room temperature. It was left stirring for 30 minutes at room temperature and then cooled to −15° C. The magnesium dibromide slurry was quickly added via cannula giving a clear yellow solution. The cyanuric chloride solution was cooled to 0° C. and equipped with an addition funnel. The Grignard solution was transferred into the addition funnel by cannula and quickly added as temperature was holding at about −5° C. The reaction mixture was left to stir as it gradually warmed to room temperature overnight. Color of the mixture changed from yellow to orange to dark red. Next day, reaction was quenched by addition of citric acid solution (50 ml, 5 wt %). THF was removed under reduced pressure and the aqueous residue was extracted with CH₂Cl₂ (3×50 ml). Organic washes were combined, dried over Na₂SO₄ and concentrated to give a red liquid. The crude product was further purified by flash chromatography (CH₂Cl₂/hexanes gradient) to give 0.45 g (17%) of product. ¹H NMR and LC-MS were consisted with the structure.

### b. 4,4′-(6-(4-isopropylphenyl)-1,3,5-triazine-2,4-diyl)dibenzonitrile

2,4-Dichloro-6-(4-isopropylphenyl)-1,3,5-triazine (1.2 g, 4.48 mmol) was dissolved in dimethoxyethane (25 ml) in a 100 ml round-bottom flask. Water (13 ml) was added and nitrogen was bubbled through the mixture for 15 minutes. Next, 4-cyanophenyl boronic acid (1.56 g, 10.29 mmol) was added, followed by potassium carbonate (3.71 g, 26.85 mmol). Tetrakis(triphenylphosphine)palladium (0.517 g, 0.45 mmol, 10 mol %) was added last. The flask was capped with a reflux condenser attached to a nitrogen bubbler. Reaction mixture was placed into a heating bath left to reflux overnight (19 hours). Next day, reaction mixture was cooled to room temperature. Volatiles were removed under reduced pressure. The residual aqueous layer was taken up in water and CH₂Cl₂ (100 ml each). Aqueous layer was separated and washed with additional CH₂Cl₂ (110 ml). Organic layers were combined, washed with water (2×100 ml), brine (100 ml), dried over MgSO₄ and concentrated to give crude product. Purification by flash chromatography (CH₂Cl₂/hexane gradient) gave 0.1 g (5.5%) of the product. Structure was confirmed by LC/MS and ¹H NMR.

### Example 2

This example illustrates the preparation of Compound C2, (3,3′-(6-(4-isopropylphenyl)-1,3,5-triazine-2,4-diyl)dibenzonitrile).

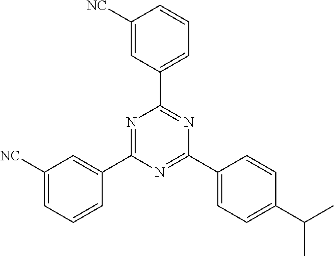 [SMILES: CC(C)c1ccc(-c2nc(-c3cccc(C#N)c3)nc(-c3cccc(C#N)c3)n2)cc1]

In a drybox, 2,4-dichloro-6-(4-isopropylphenyl)-1,3,5-triazine from Example 1 (0.2 g, 0.75 mmol), 3-cyanophenyl boronic acid (0.33 g, 2.24 mmol) and potassium phosphate (0.32 g, 1.5 mmol) were placed into a thick-walled glass tube. Palladium acetate (3.4 mg, 0.015 mmol) and SPhos (12.3 mg, 0.03 mmol) were dissolved in dry toluene (2 ml). Next, the catalyst solution was added to the glass tube and rinsed with additional toluene (1 ml). The tube was sealed with a threaded Teflon stopper, taken out of the box and placed into a 90° C. oil bath for 20 hours. Reaction mixture was cooled to room temperature, diluted with CH₂Cl₂ (30 ml) and filtered. Volatiles were removed under reduced pressure. The crude product was purified by flash chromatography (CH₂Cl₂/hexane gradient) to give 0.085 g (29.0%) of the product. Structure was confirmed by LC/MS and ¹H NMR.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges include each and every value within that range.

What is claimed is:

1. An electroactive composition comprising (a) a host, (b) a dopant, and (c) an additive having Formula I 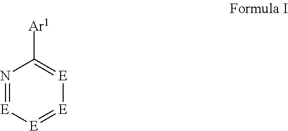
wherein:
E is the same or different at each occurrence and is N or C—Ar¹, with the proviso that at least one E=N; and
Ar¹ is the same or different at each occurrence and is H, D, or aryl, with the proviso that at least one Ar¹ is aryl.

2. The composition of claim 1, wherein the additive has a LUMO level deeper than −2.0 eV.

3. The composition of claim 1, wherein the additive has a first excited state singlet energy greater than 2.8 eV.

4. The composition of claim 1, wherein the additive has a first excited state triplet energy greater than 2.1 eV.

5. The composition of claim 1, wherein the additive is at least 10% deuterated.

6. The composition of claim 1, wherein one or two of E are N.

7. The composition of claim 1, wherein at least one Ar¹ has at least one substituent which is an electron-withdrawing group.

8. The composition of claim 1, wherein at least one Ar¹ is selected from the group consisting of phenyl, biphenyl, naphthyl, binaphthyl, phenylnaphthyl, naphthylphenyl, carbazolylphenyl, diarylaminophenyl, substituted derivatives thereof, and deuterated analogs thereof.

9. The composition of claim 1, wherein Ar¹ is a hydrocarbon aryl.

10. The composition of claim 1, wherein the additive has Formula II 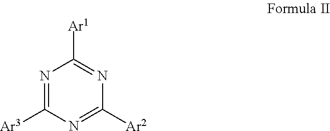
wherein:
Ar¹-Ar³ are the same or different and are H, D, or aryl, with the proviso that at least one of Ar¹-Ar³ is aryl.

11. The composition of claim 10, wherein at least one of Ar¹-Ar³ is an aryl having an electron-withdrawing group.

12. The composition of claim 1, wherein the additive has Formula III 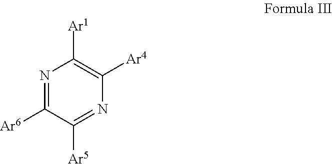
wherein:
Ar¹ and Ar⁴-Ar⁶ are the same or different and are H, D, or aryl, with the proviso that at least one of Ar¹ and Ar⁴-Ar⁶ is aryl.

13. The composition of claim 12, wherein at least one of Ar¹ and Ar⁴-Ar⁶ is an aryl having an electron-withdrawing group.

14. The composition of claim 12, wherein at least one of Ar¹ and Ar⁴-Ar⁶ is selected from the group consisting of phenyl, biphenyl, naphthyl, binaphthyl, phenylnaphthyl, naphthylphenyl, carbazolylphenyl, diarylaminophenyl, substituted derivatives thereof, and deuterated analogs thereof.

15. An organic electronic device comprising a first electrical contact, a second electrical contact and a photoactive layer therebetween, wherein the photoactive layer comprises (a) a host, (b) a dopant, and (c) an additive having Formula I 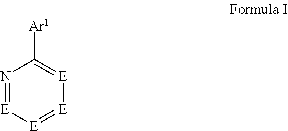
wherein:
E is the same or different at each occurrence and is N or C—Ar¹, with the proviso that at least one E=N; and
Ar¹ is the same or different at each occurrence and is H, D, or aryl, with the proviso that at least one Ar¹ is aryl.

16. The device of claim 15, wherein the photoactive layer further comprises
(d) a second host.
